(19) United States
(12) Patent Application Publication
(10) Pub. No.: US 2023/0010082 A1
(43) Pub. Date: Jan. 12, 2023

(54) AIRPORT SECURITY ECO-SYSTEM AND METHODS AND COMPUTER PROGRAM PRODUCTS USEFUL IN CONJUNCTION THEREWITH

(71) Applicant: I-SEC TECH B.V., Schiphol Oost (NL)

(72) Inventors: Daniel Jonathan GABRINER, Mirepoix (FR); Oleksandr Volodymyrovych MUROV, Diemen (NL); Ronald BUIJS, De Meern (NL)

(21) Appl. No.: 17/813,582

(22) Filed: Jul. 19, 2022

Related U.S. Application Data
(63) Continuation-in-part of application No. PCT/IL2021/050878, filed on Jul. 19, 2021.

(30) Foreign Application Priority Data
Jul. 19, 2020 (IL) 276176
Jul. 19, 2021 (IL) 284968

(51) Int. Cl. G06Q 10/06

(52) U.S. Cl. CPC G06Q 10/0631

(57) ABSTRACT

An airport security eco-system comprising: plural client applications each including a hardware processor configured for use by security agents conducting security screening of passengers, thereby to generate individual passenger data characterizing individual passengers; plural companion applications each including a hardware processor configured for use by personnel other than the security agents who require information derived from the individual passenger data, the personnel including at least one of airport authorities and government authorities, and a cloud service that manages passenger data, typically including HRF passenger data, and provides data connectivity between the client and companion applications including communicating said data to, from and between the client and companion applications.

### REFERENCE TO CO-PENDING APPLICATIONS

The present application is a continuation-in-part of PCT application no. PCT/IL2021/050878, filed Jul. 19, 2021, the entire contents of which being hereby incorporated herein by reference. Priority is claimed from Israeli Patent Application No. 276176 “Airport security eco-system and methods and computer program products useful in conjunction therewith”—filed Jul. 19, 2020, the disclosure of which application/s is hereby incorporated by reference.

### FIELD OF THIS DISCLOSURE

The present invention relates generally to software, and more particularly to software which receives, stores and processes, inter alia, data from sensors which monitor or sample humans.

### BACKGROUND FOR THIS DISCLOSURE

Airport security is a highly critical and risk-prone and time-sensitive field. Conventional airport security is described in Wikipedia's entry on that topic
en.wikipedia.org/wiki/Airport security
   I-Check is a known technology and is described e.g. here:
as.i-sec.com/products/i-check.
   NoSQL databases which relax some of the ACID properties of relational databases to yield a data model which is more flexible, are known.

FlexRule.com licenses decision management software that enables organizations who are its end-users to implement end-to-end decision automation and to adapt to changes efficiently.

The disclosures of all publications and patent documents mentioned in the specification, and of the publications and patent documents cited therein directly or indirectly, are hereby incorporated by reference other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

Certain embodiments seek to provide a system aka ECOsystem or HRFX-check system, which integrates manual and/or semi-automated systems which may be legacy systems already deployed.

Certain embodiments seek to provide an ECOsystem that is modular and expandable, that covers the complete high risk flight operation, and creates a solution that can make a very significant positive impact on waiting times, on efficiency, reporting needs, security and of course, much more.

The system herein may perform all or any subset of the following:
Process and filter passenger details upon business rules specified by a client.
The filter rules are able to be updated and/or changed and put into production within 24 hours.
The filter rules are flexible and are able to be prioritized, and may consist of multiple business rules and/or challenges.
The rule engine system accepts live data streams and various input formats over encrypted and secure lines.
The back-end only transmits information that has been SALT hashed and secured by end to end certificate encryption.
Connect to a variety of API's as to be able to show relevant gate, frequent flyer, travel doc or other information.
Check the live status of each passenger even when the original input was from a non-live stream.
Connect to DCS to be able to gather passenger information.
Lookup and update DCS records.
The operational systems in a cloud environment service multiple countries and/or airports at the same time, and on the same continent.

The system herein typically includes a population of clients e.g. cell apps wherein each client may be able to perform or may be characterized by all or any subset of the following:
Run on tablets on a ‘fixed’ position.
Run on smartphones on a mobile position.
Scan boarding passes and travel doc information, each within a second.
In no time, store passenger data on the local machine
Be connected with any wireless or mobile network protocol (3G, 4G, WiFi. etc.).
Only transmit information that has been SALT hashed, and over SSL connections only.
Devices are lockable with a unique login or barcode system.
Devices are able to synchronize passenger results within an environment so passengers do not have to be processed completely twice.
Present an easy-to-use GUI which is adaptable to the client's wishes.

The system may include agent support functionality which typically allows users (e.g. security agents) with a mobile device to scan boarding passes and passports using suitable data repository e.g. conventional or proprietary 3rd party libraries; and connects to a back-end system where it searches for a match with profiled passenger information, gate information. 3rd party information, then shows the result back to the user e.g. agent. The devices or subsystems understand what has happened on other devices or subsystems.

The system typically gathers, processes, distributes information and presents results to, inter alia, at least one agent at at least one airport. Typically: In back-end gathering of information, Airline PNR information is PGP encrypted by a public and private key. It is then transmitted by the airline e.g. through SFTP secured channels typically with TLS encryption that may be protected by a digital authentication certificate.

In back-end information processing, typically, Airline PNR information is processed by an N-APS engine that uses filtering rules provided by the airline. Filtering codes or other indicators are then generated.

In back-end N-APS data distribution, typically, processed N-APS data is encrypted using SALT hashes and stored e.g. in a back-end production and DR environment using flexible database systems.

In front-end handling of boarding pass and passport information, typically, an agent at the airport scans boarding pass (BCBP) and travel document (MRZ) information of passengers using a client app e.g. as described herein, typically on a handheld device.

In front-end manual checks by airport agents, typically, an agent verifies the origin location (LPD) and SSSS status on the boarding pass on a client app.

In back-end transfer and matching of pax data, typically, boarding pass and passport information is encrypted e.g. using a SALT hash. No data is stored on the tablet. SALT hashed information from the tablet is matched to SALT hashed information from N-APS which may be stored on a back-end. Resulting matches and information are then sent back to the handheld device.

In back-end verification of airline travel documents, typically, boarding pass and travel document information is sent to airline DCS over internal lines for travel doc verification. Results are sent and stored on a back-end and re-routed to the client app.

In back-end processing of airport departure information, departing flight information is gathered to match with N-APS filtered data and used for gate location information. In the front-end, all results may be presented, e.g. via an agent-client app. Typically, filter results, traveldoc and flight departure information are displayed on an agent's handheld device for agent use.

Functionalities of the system shown and described herein may include all or any subset of the following:

a. Provide security agents with a device which will allow the agent to scan a boarding pass and travel document. Scanning is typically configured to be straightforward and quick as to not hamper the flow of passengers. After scanning both documents, the agent is typically presented with the result of the filtered passenger information. This is typically easily visible and may have a corresponding color that could indicate a security level or steps that need to be taken for the passenger.
b. Eliminate the need for (all or a subset of) security stickers used today. As all devices are connected at any given time, after scanning the boarding pass, rather than giving the holder of the boarding pass a sticker, the system may notify the agent that the passenger has already passed processing.
c. After scanning the boarding pass and travel document, the system may connect to the DSC or mainframe and check the current security status of the passenger and update the filtered result accordingly.
d. Using the system on a tablet on a ‘fixed’ position but can also be used by non-security personnel on a mobile smartphone, thus enabling different airline agents, such as ground staff at check-in, and meet & greet agents, to already check the security status of the passengers and guide them into a designated lane for a security check if necessary, or guiding the passenger through towards the rest of the boarding process. This could reduce the amount of security staff needed and greatly improve the passenger flow, while at the same time making sure that more attention is directed towards the passengers who need it.
e. An airline courtesy employee may be presented with relevant frequent flyer information so the passenger can be guided and treated with his or her benefits.
f. The companion application typically allows local airline staff to track the flow of passengers and set that off against expected passengers. Multiple reports and statistics can be viewed. This allows staff to see trends and bottlenecks over time and allows them to fine-tune the passenger flow.

According to certain embodiments, the system herein includes at least user interfaces for at least 3 types of users, one for the security company or vendor which may be a computerized system providing agents and/or equipment for servicing flights, the human agents may themselves be end-users, one for the airport or country regulatory authorities, and one for the airline. Or, the system may include only a subset of these three.

Features combined herein may alternatively be provided separately; features described separately herein may alternatively be combined.

The following terms may be construed either in accordance with any definition thereof appearing in the prior art literature or in accordance with the specification, or to include in their respective scopes, the following:

The term “ECOsystem” as used herein may include a standalone system (or system of systems), including hardware processors and dedicated to the HRF environment. The system of FIG. 1 is an example of an ecosystem. The ecosystem is separate from, but may interface, e.g. via suitable system interfaces, with (typically via plural supported API's), other networks and systems which may be present in an airport environment. Typically, the ECOsystem is expandable, e.g. is built to enable new modules e.g. a connector to reporting system, additional check/s to be performed on existing scanned information, to be added. Typically, expandability aka modularity is provided by gathering information in a cloud service, from client application/s. thus allowing multiple checks to be run, including expanded checks added later, which generates relevant information to send back to other networks or systems. A single ecosystem may service a single airport, or one ecosystem may service plural airports e.g. in a single region. Typically, ecosystems do not communicate with one another.

As used herein the term “biometric backbone” may include a passengers' biometric data repository which may be generated by using suitable sensors such as cameras, document scanners, fingerprint readers, etc. To collect data from passengers and from their documents e.g. passports and/or boarding passes. Icons showing humans with suitcases on wheels, in FIG. 1, denote passengers, typically seeking to board a flight (as denoted by the aircraft icon in FIG. 1 at reference numeral 4). Biometric backbone is used herein to denote a computerized service which may be provided by certain airports for sharing gathered biometric data with vendors that work in the same airport so that a single biometric data repository may be used by multiple systems of multiple vendors to identify passengers in that airport.

As used herein the term “connector” may include any data communication interface or API between two systems; the connector typically allows data to be transferred, processed and understood by systems on both or all sides of the connector, and may include a communication protocol known to and observed by both or all sides.

As used herein, the term “filter” (typically performed by a passenger filtering subsystem) may include classifying passengers as being of different risk levels, and providing data and/or alerts derived from this classification to at least one system. Typically, filtering includes assigning ‘security clearance’ to passengers who match certain security criteria.

As used herein (e.g. in FIG. 3). the term “flex rule” is used as an example of a decision automation platform.

“Elastic” is used as an example of a search engine, typically full-text, typically distributed, typically multitenant-capable, typically having a suitable HTTP web interface, typically with schema-free JSON documents.

“Kibana” is used as an example of a data visualization dashboard which may be in data communication with a search engine such as but not limited to Elasticsearch. The dashboard typically provides visualization functionality on top of content or data which may be indexed e.g. on an Elasticsearch cluster. The dashboard may support creation, by users, of visualizations such as bar and/or line and/or scatter plots and/or pie charts and/or maps on top of data which may have been collected by the system shown and described herein and/or may by provided to the system shown and described herein, by external systems.

Single sign-on (SSO) is used as an example of an authentication scheme that allows users to log into the system shown and described herein, typically using a single ID and password to log into plural related, yet independent, software systems such as ROM. SARA, HR systems, or corporate accounts. Authentication typically relies on a suitable protocol e.g. Lightweight Directory Access Protocol (LDAP) and may use LDAP databases on (directory) servers, OPENLD or Google.

SARA aka Security Airport Real time Application is referred to herein as an example of a mobile manpower management tool. One such tool is available from I-SEC for employee quality management and reporting. This tool may provide a dashboard overview, showing, live, where employees have been sent, without tracking them. The tool may allow a supervisor to identify needs and to assign tasks to employees to alleviate these needs. If the plastic gloves at lane 4 have run out, for instance, set a task to a person or a defined area to make sure that someone brings a pair of new gloves as quickly as possible. Or, to ensure that everyone follows and signs for a daily briefing, the tool may include a briefing subsystem which allows a supervisor to add a briefing and assign it to all or selected employees and to follow up on them later. The tool may include a logbook feature which provides management, aka supervisors, a summary of all events of daily operation. The tool may include employee overview functionality e.g. smart filter functions and search techniques allowing a supervisor to identify employee answering to certain criteria in near real time or in seconds. Typically, the tool is scalable. The tool may be used in multiple locations at the same time. The tool is able to connect to external sources and is typically adaptable to add even more.

“N-APS” is used herein as an example of scanning software, or as an example of a subsystem which is configured for pre-screening passenger information e.g. by reading PNR data and using rules to filter passengers e.g. before they even get to the airport, thereby to customize security checks for different passengers, responsive to at least one result of the filtering. For example, in some countries, passengers travelling alone may undergo different security checks than those travelling with children. Also, infant passengers may undergo different (typically less) security checks relative to adults. Also, female passengers may undergo security checks administered by females, whereas male passengers may undergo security checks administered by males. Also, passengers with pace-makers or known medical conditions may undergo different security checks than passengers with no known medical condition.

The N-APS passenger filtering system of FIG. 1 typically comprises an HRFX service and may comprise a connector.

ROM, or I-SEC's ROM software. is an example of a system for real-time operational management of a workforce. FIG. 9 is a screenshot which illustrates functionalities and views, all or any subset of which may be provided, by real time workforce management software.

Acronyms used herein include:

APS—Advanced Passenger Screening (predecessor of N-APS); a first business rule engine that can filter passengers based upon predefined criteria, or, more generally. any security screening.

### DCS—Departure Control System

ETD—Explosive Trace Detection device
FRF—frequent flyer

### HRF—High Risk Flight

HRFX—Ecosystem that automates a variety of HRF processes
I-BOX—A client device on a cart that used a full page passport scanner and an external battery to work.

### MRZ—Machine Readable Zone

N-APS New Advanced Passenger Screening or filtering; a second business rule engine that can filter passengers based upon predefined criteria or more generally any security screening.
PAX—Short for passenger

### PNR—Passenger Name Record

PRM—People with Reduced Mobility

### SSO—Single Sign On

SSSS—Quad S, a passenger marked as “Selectee” by a regulating authority

### UM—Unaccompanied Minor.

It is appreciated that any reference herein to, or recitation of, an operation being performed is. e.g. if the operation is performed at least partly in software. intended to include both an embodiment where the operation is performed in its entirety by a server A, and also to include any type of “outsourcing” or “cloud” embodiments in which the operation, or portions thereof. is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations, and, instead, the remote processor P itself may receive output/s of portion/s of the operation from yet another processor/s P′, may be deployed off-shore relative to P, or “on a cloud”, and so forth.

At least the following embodiments are included in the scope of the present invention:

Embodiment 1. An airport security eco-system comprising:

plural client applications each including a hardware processor configured for use by security agents conducting security screening of passengers. thereby to generate individual passenger data characterizing individual passengers;
plural companion applications each including a hardware processor configured for use by personnel other than the security agents who require information derived from the individual passenger data, the personnel including at least one of airport authorities and government authorities, and
a cloud service that manages passenger data, typically including HRF passenger data, and provides data connectivity between the client and companion applications including communicating the data to, from and between the client and companion applications.

Embodiment 2. The system of any of the preceding embodiments, wherein the information comprises at least a portion of the passenger data.

Embodiment 3. The system of any of the preceding embodiments, wherein the client applications are each configured to scan at least one physical document, such as a passport or boarding pass, borne by passengers.

Embodiment 4. The system of any of the preceding embodiments, wherein the data is communicated between the client and companion applications in near-real time.

Embodiment 5. The system of any of the preceding embodiments, wherein the data is communicated to the cloud service in near-real time.

Embodiment 6. The system of any of the preceding embodiments, wherein the data is communicated from the cloud service in near-real time.

Embodiment 7. The system of any of the preceding embodiments, wherein the cloud service is operative to present, to at least one security agent using at least one client application, biometric information regarding at least one passenger gathered by the cloud service via an authentication connector aka biometric connector from a legacy biometric backbone deployed in an airport.

Embodiment 8. The system of any of the preceding embodiments, wherein the cloud service is operative to generate a display data provided by a boarding connector, which interfaces with a legacy departure control system (DCS), wherein the display is presented to at least one security agent using at least one client application.

Embodiment 9. The system of any of the preceding embodiments, and also comprising a passenger filtering subsystem which gathers PNR data from at least one airline and applies rules to the PNR data.

Embodiment 10. The system of any of the preceding embodiments, and wherein the rules are modifiable via at least one of the plural companion applications.

Embodiment 11. The system of any of the preceding embodiments, wherein the system interfaces with employee management software, thereby to facilitate management of at least the security agents, and wherein the system provides the employee management software with passenger flow data derived from the individual passenger data.

Embodiment 12. The system of any of the preceding embodiments, wherein the system interfaces with employee management software, thereby to facilitate management of at least the security agents, and wherein the system provides the employee management software with data, identifying delayed transfer passengers, which is generated by learning from an airport information system of a delayed incoming aircraft due to arrive late, and looking up (e.g. by interfacing with an airline ticketing system) how many passengers from the delayed incoming aircraft are transferring to a given departing flight.

Embodiment 13. The system of any of the preceding embodiments, wherein the individual passenger data includes at least one of the following: HRF passenger data, Birthdate, DocumentNumber, FamilySize, Gender, GroupSize, Family, Continuous Itinerary, FirstNameSecret, LastNameSecret, FirstNameFull, LastNameFull, FirstName3Char, FirstName4Char. FirstName5Char, LastName3Char, LastName4Char, LastName5Char, Itinerary. PNR Code, Transit, PaxAQQ. SegmentAirportCodes, TotalSegments, Carrier, FlightNumber, Departure, DepartureTime, Destination, DestinationTime, Origin. OriginTime, and HasAPSCode.

Embodiment 14. The system of any of the preceding embodiments, wherein the cloud service securely manages passenger data, including HRF passenger data.

Embodiment 15. An efficient flight security method comprising: providing data in real time or in near-real time, to and from plural systems, including at least one airport system and/or at least one airline system and/or at least one agent/equipment management system which deploys agents and/or equipment servicing passengers of flights by providing security approval thereof.

Embodiment 16. A method according to of the preceding embodiments and wherein the method also comprises generating new data in real time, responsive to data provided in real time by at least a first system from among the plural systems, wherein the new data characterizes passengers of at least one flight and/or agents or equipment used to provide security approval of the passengers of the at least one flight, and providing the new data in real time to at least a second system from among the plural systems.

Embodiment 17. A computer program product, comprising a non-transitory tangible computer readable medium having computer readable program code embodied therein, the computer readable program code adapted to be executed to implement an efficient flight security method comprising providing data in real time or in near real time, to and from plural systems, including at least one airport system and/or at least one airline system and/or at least one agent/equipment management system which deploys agents and/or equipment servicing passengers of flights by providing security approval thereof.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes or a general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s. display and input means may be used to process, display e.g. on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs. DVDs, BluRays, magnetic-optical discs or other discs; RAMs, random access memories, EPROMs, EEPROMs, magnetic or optical or other cards, for storing, and keyboard or mouse for accepting. Modules illustrated and described herein may include any one or combination or plurality of: a server. a data processor, a memory/computer storage, a communication interface (wireless (e.g. BLE) or wired (e.g. USB)), a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. Use of nouns in singular form is not intended to be limiting; thus the term processor is intended to include a plurality of processing units which may be distributed or remote, the term server is intended to include plural typically interconnected modules running on plural respective servers, and so forth.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which. when executed by the machine, implements all or any subset of the apparatus, methods. features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s. or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g. chips, which may be co-located or remote from one another. Any controller or processor may, for example, comprise at least one CPU, DSP, FPGA or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs), or may comprise a microprocessor that runs suitable software. or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser. system version, or individual product or protocol in question, is incorporated by reference herein in its entirety.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor. may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface or other system illustrated or described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may conmunicate between themselves via a suitable computer network.

The system shown and described herein may include user interface/s e.g. as described herein which may for example include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus the term user interface or “ur” as used herein includes also the underlying logic which controls the data presented to the user e.g. by the system display and receives and processes and/or provides to other modules herein, data entered by a user e.g. using her or his workstation/device.

### BRIEF DESCRIPTION OF THE DRAWINGS

Certain embodiments of the present invention are illustrated in the following drawings; in the block diagrams, arrows between modules may be implemented as APIs and any suitable technology may be used for interconnecting functional components or modules illustrated herein in a suitable sequence or order e.g. via a suitable API/Interface. For example, state of the art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML. Specifically:

FIGS. 1-3 are simplified semi-pictorial semi-block diagram illustrations of embodiments of the present invention whose various components may be provided separately or in any combination, either within the embodiments, or therebetween.

FIGS. 4-8 are tables useful in understanding certain embodiments.

FIG. 9 is a screenshot which illustrates functionalities and views, all or any subset of which may be provided, by real time workforce management software.

Methods and systems included in the scope of the present invention may include any subset or all of the functional blocks shown in the specifically illustrated implementations by way of example, in any suitable order e.g. as shown. Flows may include all or any subset of the illustrated operations, suitably ordered e.g. as shown. Tables herein may include all or any subset of the fields and/or records and/or cells and/or rows and/or columns described.

Computational, functional or logical components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Each functionality or method herein may be implemented in software (e.g. for execution on suitable processing hardware such as a microprocessor or digital signal processor), firmware, hardware (using any conventional hardware technology such as Integrated Circuit technology) or any combination thereof.

Functionality or operations stipulated as being software-implemented may alternatively be wholly or fully implemented by an equivalent hardware or firmware module, and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware in which case all or any subset of the variables. parameters, and computations described herein may be in hardware.

Any module or functionality described herein may comprise a suitably configured hardware component or circuitry. Alternatively or in addition. modules or functionality described herein may be performed by a general purpose computer or more generally by a suitable microprocessor, configured in accordance with: methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option such as but not limited to FPGA, ASIC or DSP, or any suitable combination thereof.

Any hardware component mentioned herein may in fact include either one or more hardware devices e.g. chips, which may be co-located or remote from one another.

Any method described herein is intended to include within the scope of the embodiments of the present invention also any software or computer program performing all or any subset of the method's operations, including a mobile application, platform or operating system e.g. as stored in a medium, as well as combining the computer program with a hardware device to perform all or any subset of the operations of the method.

Data can be stored on one or more tangible or intangible computer readable media stored at one or more different locations, different network nodes, or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary. tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

Certain embodiments include a high risk flight (HRF) passenger management system typically cloud-based, which typically provides secure, modular information gathering and processing, to monitor and improve efficiency and quality in an entirely. or for the most part, paperless and stickerless environment.

According to some approaches, computerized technologies are used to support high risk flight operations e.g. technology (as opposed to manual handling) and may be used only to filter passengers to determine which passengers are more positive than others. Thus, a partial technological solution is used to support manual HRF operations.

The system herein, aka HRFX—Check, rather than using technology only at certain points in the HRF operation, instead integrates these points into an integrated system or umbrella, that, by automating and/or integrating more HRF flight operations, adds functionality that was previously impossible e.g. automation of reporting and cross checks, eliminating paper and/or stickers, and digitally generating and sending suitable alerts such as all or any subset of: alert when a passengers SSSS status has changed, alert when a variable percentage of passengers are still missing at a certain time before flight departure, alert when transferring passengers is delayed because of late incoming aircraft, alert when not enough random passengers are referred to ETD, at suitable times.

Typically the system accumulates, in a secure way, compliant with privacy legislation. data from plural databases, and then generates and presents comprehensive reports to an airline and/or regulating bodies without manual intervention. Typically the system can connect to a biometric backbone to recognize passengers and minimize touchpoints to ensure a better flow. Typically, a SSO (single sign on) service is used to provide unique and traceable logins for the HRFX-Client devices.

Typically the system includes an HRFX—Cloud service that securely manages and processes HRF passenger related information, and/or (multiple instances of an) HRFX—Client application that scans boarding passes and travel documents and typically connects to a cloud service e.g. the HRFX—Cloud service through a suitable communication technology such as WiFi or 4G.

Typically, the cloud service securely stores and securely transports HRF passenger data. Typically, all data is encrypted, even at rest, in the Cloud service. Data between the APP and CLOUD API is typically encrypted. All data is typically hashed and is typically moved only over SSL connections.

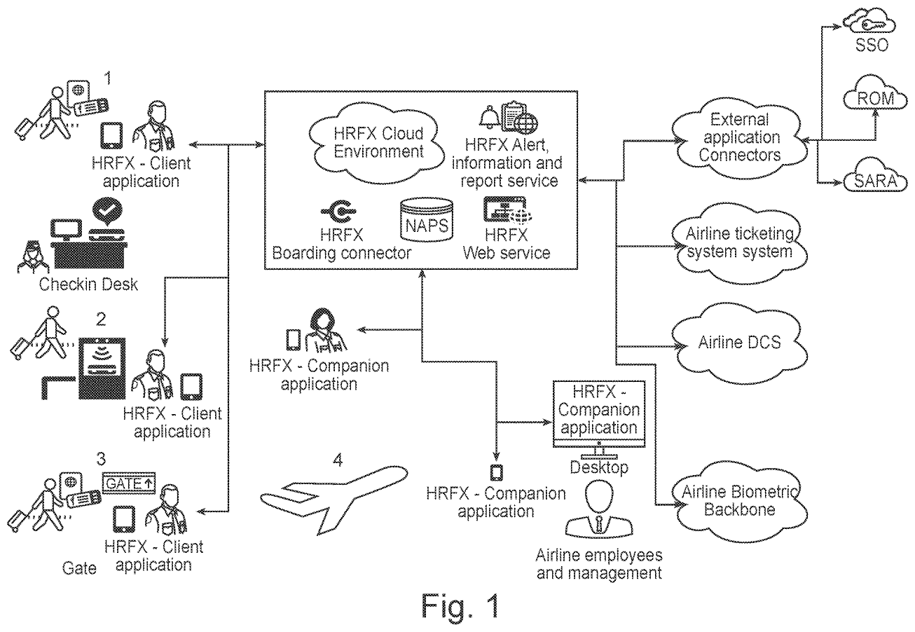

The HRFX—Cloud service is typically characterized by all or any subset of the following:
Servers and services running in an OWN or Azure cloud environment
Guarantees and secures information gathering from all different modules
Ensures information distribution to all different modules
Ensures connectivity between, to and from HRFX client applications and HRFX companion applications.
   The HRFX—client application is typically characterized by all or any subset of the following:
Used by the security agent e.g. to scan boarding passes and travel documents using any suitable imager or camera
Shows relevant passenger information gathered from the HRFX—Cloud service
Shows relevant results from HRFX modules e.g. all or any subset of: N-APS, HRFX—Web service, HRFX—Boarding connector, HRFX—Biometric connector.
Directs passengers to, say, ETD, Gate Reader, additional security check, airline desk, depending on internally stored rules or logic, e.g. direct passenger to desk if pax data is incomplete.
Live N-APS processing for new or additional passengers
Communicates with other HRFX clients to give messages to yield stickerless operation
Instructs operator to perform security interview, if required
Allows the agent to view and/or interact with security clearance given automatically by the NAPS system
Allows the agent to set the security status of a passenger
Allows the agent to control the passenger flow towards the interviewer and or selectee check.
   All or any subset of the following modules may be provided (e.g. as shown in FIG. 1):
   i.HRFX Web service:
   ii. HRFX—Companion application; View live statistics/dashboard of passenger flow and/or amount of people sent to specific security checks, and/or download reports e.g. on a mobile application or website.
   iii. HRFX—Alert, information & Report service:
   iv. HRFX—Boarding connector.
   v. HRFX—Authentication connector, connect to available biometric backbone to identify passengers on touch points throughout the airport, and/or connect e.g. to SSO providers to use for agent login on the HRFX—client devices or other logins for the HRFX—companion app
   vi. N-APS passenger filtering system
   vii. HRFX—SARA connector, connect to Security Airport Real Time Application to manage employee quality.
   viii. HRFX—ROM connector, connect to Real Time Operational planning system to send and receive information on passenger flow so a planner can act upon that.

According to certain embodiments, the above modules are respectively characterized as follows:

i. The HRFX Web service may provide typically bi-directional information exchange with the airline ticketing system and DCS airport system. Typically connects the HRFX—Cloud service to other systems e.g. all or any subset of:
Airline ticketing system—to verify and gather Traveldoc status and/or SSSS of passenger
DCS (Departure Control System) of the airport- to verify and gather departure gate of passenger and/or passenger's information (e.g. if the passenger is unknown to the HRFX—Cloud service)
   ii. HRFX— Companion application; view live statistics/dashboard of passenger flow, and/or amount of people sent to specific security checks, and/or download reports. Typically comprises a mobile application or website that runs on a handheld device and that displays reports and gives or presents alerts e.g. as created by the HRFX—
   Alert, information and report service. Typically, the application has (or may be configured to have) different rights or privileges or authorizations e.g. to show relevant alerts, information and reports to supervisory, airline staff or back-end office.
   May have a supervisor mode used, say, to overview totals: and/or for missing/additional security check etc.
   May have airline staff mode e.g. to view and measure flow of passengers, and/or see relevant reports.
   All or any subset of the following may be provided:
TSA (random) continuous search requirement standard
SSSS amount and type of check
% of passengers that received ETD check
Live push message for (new or additional) SSSS passenger
   iii. HRFX—Alert, Information & Report service: may set alerts upon predefined rules e.g. to the HRFX—Companion application. May create and send statistical reports to designated recipients. Airline/Airport Alert, Information & Report services options may include all or any subset of: measure and display on dashboard, flow of passengers arriving, notifications of total missing passengers. SSSS identification, notification on how many SSSS passengers are missing, notification of passengers whose security status has changed, notification of PNR group composition, notification of passenger holding hold baggage vs carry-on only, identification of passenger's priority/frequent flyer status, identification of PRM listed passengers, identification of UM listed passengers, unusual travel document identification, live departure gate information to direct passenger, identification of passengers with immigration issues, option to record ETD follow-up and details in case of an alarm protocol, option to notify supervisor/authorities re pax displaying unusual behavior or found holding harmful/suspicious items, flight summary report (airline, vendor), reports to third parties (authorities), passenger interview sign-off.
   iv. HRFX—Boarding connector; board passengers onto an aircraft. Typically this comprises software that connects to the airline DSC boarding system and allows HRFX passengers to be boarded in the airline system onto the aircraft.
   v. HRFX—Authentication connector which typically comprises software that connects to an available biometric backbone and allows passengers to be recognized, e.g. without having their boarding pass or travel document scanned, by the HRFX-Client application if they previously enrolled, including providing biometrics, at a “starting point”. May allow the HRFX—based system e.g. cloud service and/or client app, to connect to an SSO (single sign on) provider and use those credentials for the HRFX—client and/or companion applications.
   vi. N-APS passenger filtering system; filters passengers based on predefined rules. Typically includes a business rule engine service that gathers PNR data from airlines and processes the PNR data using predefined rules. Typically, rules can be modified instantly without programming. Typically allows multiple import and export formats such as but not limited to, say, XML, TXT, SOAP service, and direct database communication.
   vii. HRFX—SARA connector, allows information to be shared with the Employee Management solution SARA. Allows to see, say, employees' training status, overall performance, and enables them to create reports like incident, flight and performance reports. Scan2Report functionality may be provided which scans passenger or passenger related information (barcode, MRZ, to instantly create SARA reports.
   viii. HRFX—ROM connector allows HRFX—Check system shown and described herein, to connect to a ROM (say) planning system or to any system for real-time operational management of a workforce.

Thus, planners can be alerted when the need for agents in the operation increases or decreases. Data may be provided about transfer passengers. so that if a bulk of passengers is expected late. there are enough agents. Data may be provided if a high (as defined internally) percentage of passengers has already boarded, indicating that less agents are now needed at the gate. Data may be provided re waiting times and passenger flow, so that a planner can, responsively, add or reduce agents to optimize passenger flow and cost-effectiveness thereof.

FIGS. 1-3 are example embodiments.

The HRFX Client application of FIG. 1 typically comprises an application used by a security agent (or supervisor thereof) conducting security screening of passengers. This application typically runs on a dedicated device (e.g. an Iphone or IPAD or other mobile device used for the client application. Typically. this device is ‘dedicated’ only to this application so the application runs as securely as possible and no agent interference on the device is possible) and typically includes interfaces for agent or supervisor that are running the security screening, and typically no other interfaces.

The companion application is typically only for supporting personnel. e.g. the client, airport or government authorities that seek information regarding the security screening conducted by the HRFX Client application. Security supervisors or duty managers from an organization conducting the security screening, and/or employees from an airline for whom the security screening is being conducted, and/or airport and/or government authorities. may each seek such information. Typically this companion application which is not used to conduct the security screening, does not run on a dedicated device.

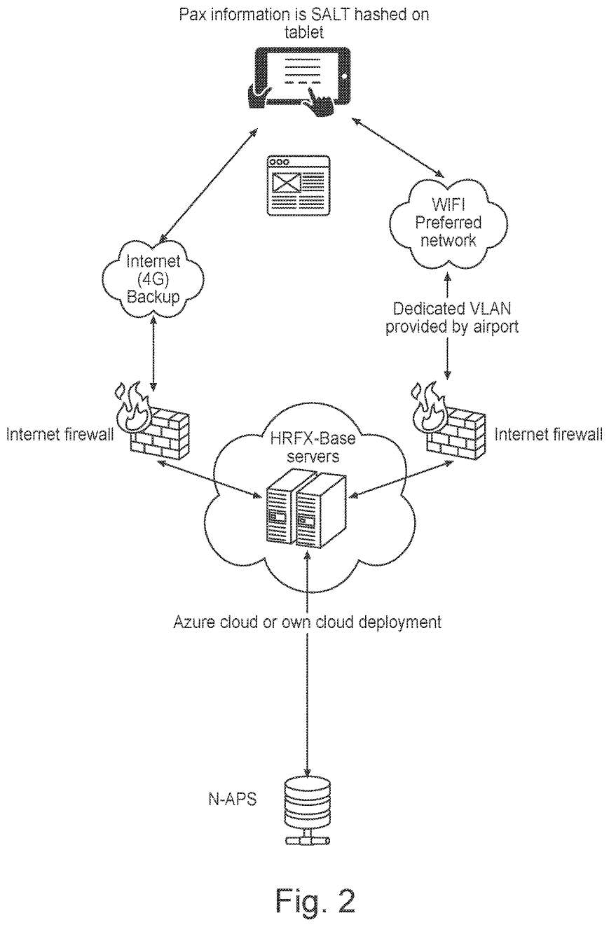

The tablet shown in FIG. 2 may correspond to the HRFX-client application used by a security agent.

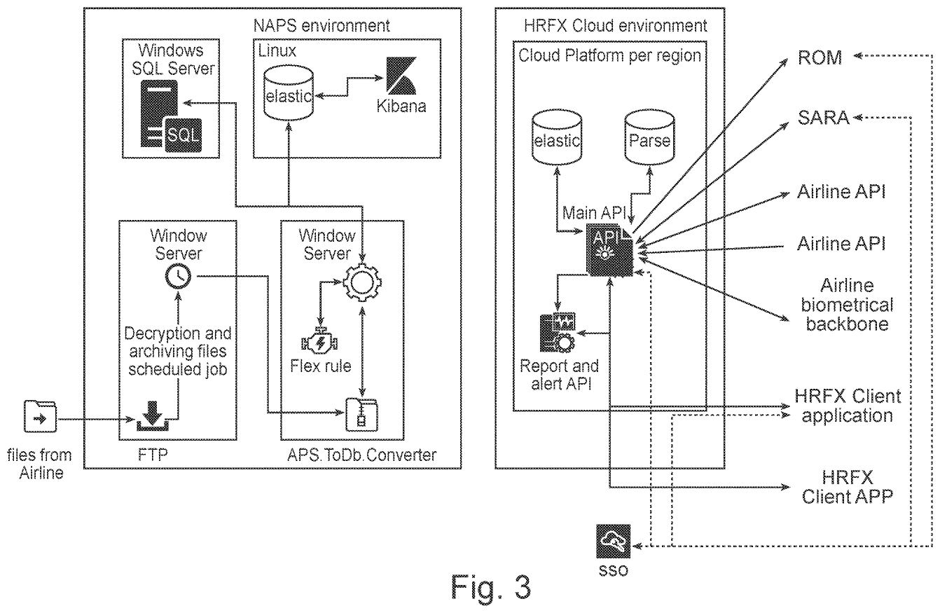

FIG. 3 describes interfaces, all or any subset of which may be provided, between client and companion apps. e.g. the client and companion apps of FIG. 1, and other systems.

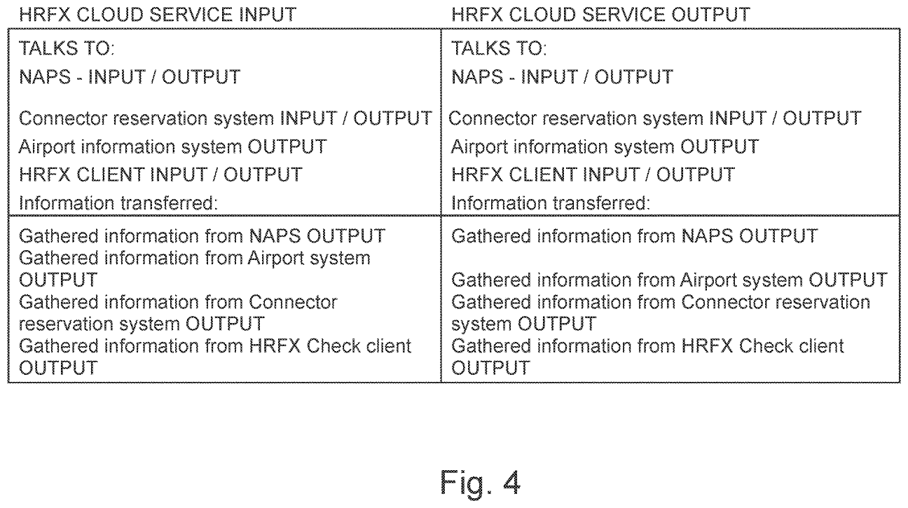

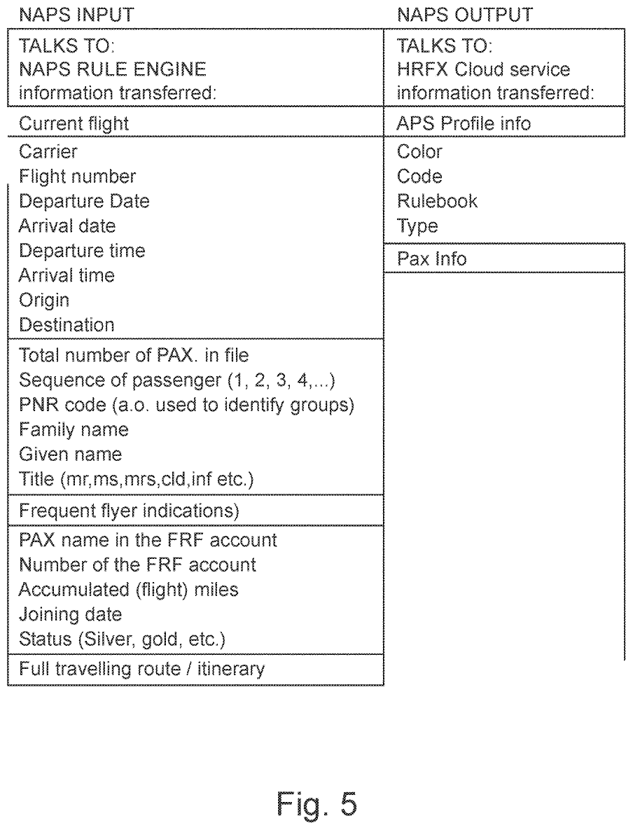

FIGS. 4-8 describe inputs and outputs of each of various modules which may be provided. Each module may talk to or have data communication or data connectivity with, all or any subset of the modules stipulated. Each module may gather and/or may transfer all or any subset of the information elements stipulated in FIGS. 4-8. Specifically, FIG. 4 relates to the HRFX cloud service e.g. the HRFX cloud environment of FIGS. 1 and/or 3. FIG. 5 relates to the NAPS environment of FIG. 3. In FIG. 5, pax info may include all or any subset of the following fields or data elements: Birthdate, DocumentNumber, FamilySize, Gender, GroupSize, Family, Continuous Itinerary, FirstNameSecret, LastNameSecret, FirstNameFull, LastNameFull, FirstName3Char, FirstName4Char. FirstName5Char, LastName3Char, LastName4Char. LastName5Char, Itinerary. PNR Code, Transit, PaxAQQ, SegmentAirportCodes, TotalSegments, Carrier, FlightNumber, Departure, DepartureTime, Destination, DestinationTime, Origin, OriginTime, HasAPSCode.

The full travelling route/itinerary may include all or any subset of the following fields or data elements, for all legs: Departure station. Arriving station, Departure date

Arrival date, Departure time, Arrival time, Actual carrier (typically no code share) Flight numbers, Booking date, Booking location, Form of payment, Ticketprice, Currency used, Amount, Booking class/cabin (e.g. economy/business/first), Employee. ID number
Joining date, Carrier of employment.

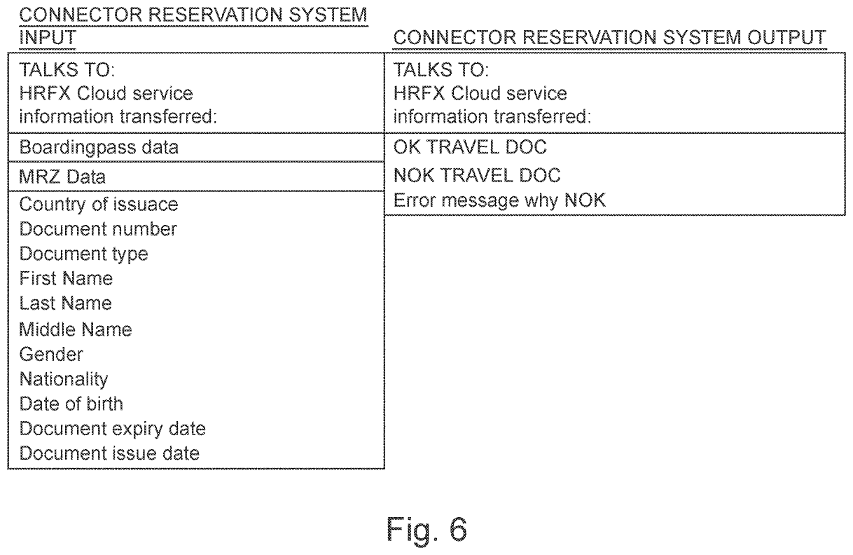

FIG. 6 relates to a connector reservation subsystem. The connector reservation subsystem of FIG. 6 is typically configured to connect to the airline reservation system to send and receive information gathered by the HRFX-Check client and processed HFRX-Cloud service. Typically, boarding pass and/or passport information is sent and live SSSS (selectee status) data is returned, and/or the passenger traveldoc status, and/or any passenger related information that the airline knows, but the system herein does not.

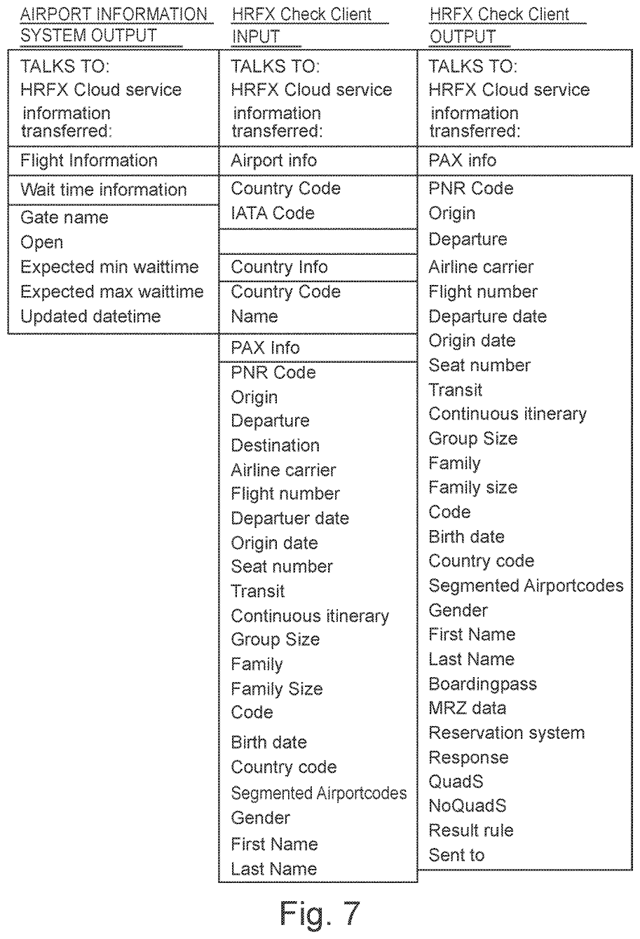

FIG. 7 relates to an airport information system.

In FIG. 7, flight information may include may include all or any subset of the following fields or data elements: LastUpdateAtActual landing time, Actual off block time, Aircraft registration, Aircraft type, Baggage claim, Checkin all locations. Codeshares, Estimated landing time, Expected boarding time, Expected gate closing, Expected gate open, Expected time on belt. Expected security filter, Airline public name, Flight direction, Flight name, Flight number, Gate, Pier, Main flight, Prefix IATA, Prefix ICAO, Airline code, Route Schedule datetime, Service type, Terminal, Transfer positions.

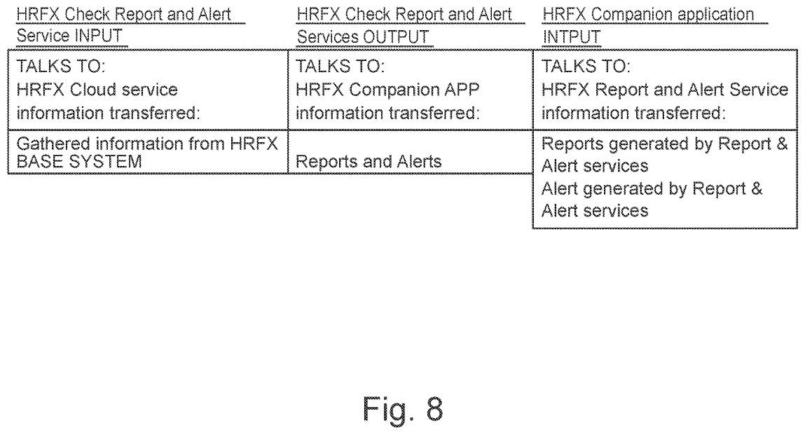

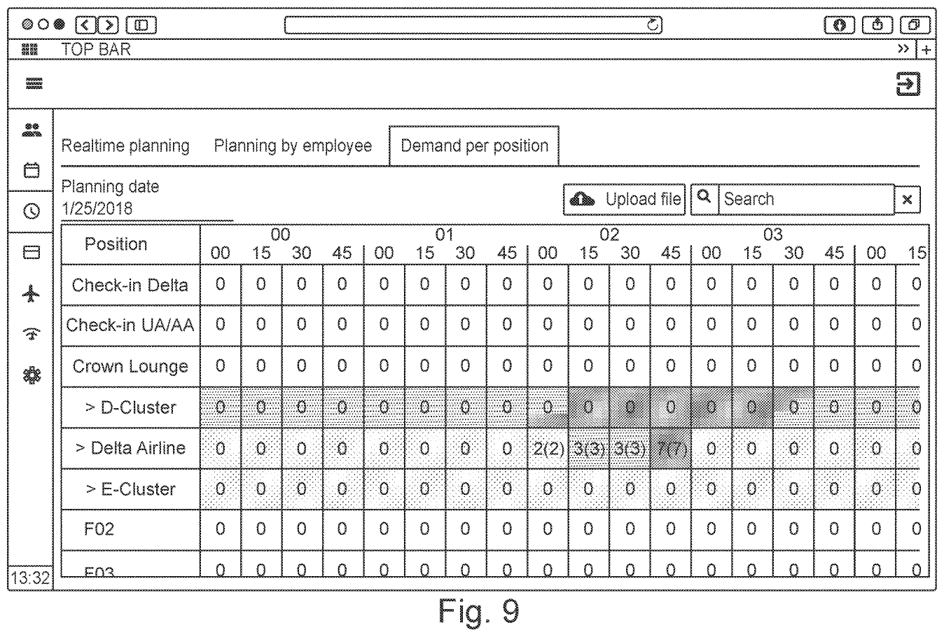

FIG. 8 relates to modules ii and iii herein.

The system herein may be used to reduce waiting times. For example, upon learning of a late arrival of an aircraft, whose data may be provided by an airport information system (whose outputs may include all or any subset of those shown in FIG. 7), the system may look up the number of transferring passengers that are moving from that aircraft to an HRF (high risk flight) that is departing, and generate an alert indicating, say, that 50 late passengers will be arriving for which a suitable number of security agents at the window of time in which the HRF flight is preparing to depart. Alternatively or in addition, the HRF X client can be used by non-security personnel to scan documents, thus only passengers that need attention need to wait in security lines for more scarce security personnel. Alternatively or in addition, the system may connect to a reservation system e.g. via a connector (e.g. as shown in FIG. 6) that may allow additional checks to be run. Thus, for example, passengers need not wait in another line for visa requirement updates. Alternatively or in addition, the boarding connector (e.g. module iv described herein) may be used to obviate any need to have passengers waiting in line. post security check, to board the aircraft.

It is appreciated that the system herein may interface with employee management software, thereby to facilitate management of at least the security agents. The system may provide the employee management software with data, identifying delayed transfer passengers, which is generated by learning from an airport information system of a delayed incoming aircraft due to arrive late, and looking up (e.g. by interfacing with an airline ticketing system) how many passengers from the delayed incoming aircraft are transferring to a given departing flight. It is appreciated that the connector to ROM on the top right of FIG. 1, may provide this transfer information.

Alternatively or in addition, the system herein may be used to facilitate handling of high value customers (who are entitled to a higher quality of service than other customers) including identifying these customers timely and directing these customers to their queues or advantages.

The system herein may be used to eliminate cross checks used today, even in state-of-the-art airports. For example, by knowing who is a ‘last minute selectee’ aka SSSS, the system may send a live alert to a supervisor, thus preventing any ‘last minute selectee’ from boarding the aircraft and causing a security delay. Or, the alert allows security staff to act quickly if a passenger becomes an SSSS when already onboard.

Alternatively or in addition, immigration requirement check and/or APIS information and/or boarding by zones, may be automated by the system herein.

The system herein may be used to eliminate paper and/or stickers used today even in state-of-the-art airports. For example, conventionally, passengers get a sticker upon passing HRF screening and the sticker is what identifies that they have passed screening. Also, supervisors conventionally fill in manual documentation listing which selectees were identified and or screened. Also, conventionally, extensive manual reporting is generated for regulating authorities and airlines. None of this is necessary when the HRFX check system of FIG. 1 is used because this system can digitally provide all or any subset of the above functionalities e.g. as described herein with reference to FIG. 3 inter alia.
For example, the HRFX-Cloud service typically knows expected travel times and transfers from the PNR file provided by the airline and a CRON-job looks up the corresponding flights in real-time and reports back to the cloud service if any of the flights carrying transfers is delayed. It is appreciated that CRON is an example of a utility which, e.g. for automating repetitive tasks, schedules a command or script on a server to run at a given time and date. The task itself, as scheduled, is termed a CRON-job.
Alternatively or in addition, the HRFX-Cloud service may send a message to the ALERT and REPORTING Service which delivers the message to the ROM operational management software which then shows delays as computed, to a planner.

Statistics of passenger flow may include all or any subset of: Number of pax expected on a given flight, Number of pax that were on that flight, Number of pax that are transferring to that flight, number of pax that are delayed because their previous flight is delayed, Number of pax that passed X-Check. Number of pax that got a security reference from X-check (which may be color-coded e.g. green, red. yellow—green for example may denote passengers (aka pax) already assigned security clearance, number of pax that got a travel indication, number of passengers sent to certain specific security checks, number of passengers who have not yet checked in. HRF passenger related information aka HRF passenger data may include conventional PNR (Passenger Name Record) data from the airline which may include all or any subset of the following types of data: travel, transfer, frequent flyer. seating, ticket and other relevant information, airline security status.

Any suitable miles may be used for filtering such as, for example, that an airport in a given country may denote nationals of certain countries as higher risk than nationals of other countries. Filtering may also identify high risk behavioural indicators. Such indicators may be collected through observation of passengers when on their own or during questioning, and/or through monitoring over time by humans and/or by machines, to identify indicators correlated with intent to perform illegal activity. Such indicators may for example include over-threshold sweating and/or trembling and/or unusual eye activity such as over-threshold eye movement or staring or refusal to make eye contact, changing appearance whether relative to passport or during the passenger's time in airport. Monitoring of a passenger. as s/he proceeds from the airport entry point to, say, bag drop. to security, to boarding gates and to immigration, may yield data that is stored in association with a given, “correct”, passenger e.g. based on a biometric token assigned to each passenger. For example, if a passenger is detected having unusual eye activity, the passenger's face may be recognized and the data about her or his unusual eye activity may then be stored in a data record associated with the passenger associated with the recognized face. The token may for example comprise data characterizing the passenger's face, which may be collected by imaging the passenger's face and using facial recognition. Passenger A's biometric data, once captured, may be checked against system-stored or passenger-presented travel documents.

The companion app described herein may be used by airport authorities, or government authorities, or airline authorizes, or all 3. Each user or group of users may be approved to see different types of data, via the companion companion app. According to certain embodiments, for example, an airline can see, filter and download statistics reports.

The term HRFX as used herein is intended to include any automated system to handle high risk flights and may include software modules which communicate with one another such as the HRFX cloud (aka cloud service, cloud environment) described herein and/or HRFX-check, and/or HRFX-client, described herein.

The ROM system (aka ROM planning system) described herein is typically configured to allow planners to see, allocate and dispatch live or human resources to ensure there are sufficient agents available to secure given HRF flights. The HRFX cloud may send data to ROM which predicts pressure or load on security agents as well as deviation from existing predictions due to, say, delays or cancellations. The ROM may be connected to the HRFX system and/or to a roster planning system. The ROM may be associated with mobile devices which agents use to check in and out of their tasks and shifts.

Referring again to FIG. 2. it is appreciated that all traffic may use https SSL traffic and/or may use Oauth 2.0 authentication or may otherwise be secured. It is appreciated that typically, the back-end servers are protected by at least one firewall e.g. an internal firewall and an external firewall.

Passenger information on a tablet e.g. of any app described herein may be suitably secured or hashed e.g. using a SALT hash. The (typically SALT hashed) information from a table may be matched to data from the system's flexible database or N-APS (which is also typically secured e.g. hashed using, say. a SALT hash).

Thus certain embodiments of the system herein are in data communication. direct or indirect, e.g. as described herein, with airport information systems (e.g. such as DCs and/or a computerized service provided by an airport for gathering biometric data) and/or with airline ticketing systems and/or with agent and/or sensor deployment systems (such as ROM which control deployment of human agents and/or of sensors for processing passengers, such as cameras and/or sensors and/or audio recording equipment and/or document scanners and/or any sensor which reads passengers' biometric data and/or Explosive Trace Detection devices, or such as SARA aka Security Airport Real time Application). Any of the above systems may be legacy systems which are already deployed. thereby cutting down on R & D costs and time to market.

Certain embodiments also include a hardware processor to process data regarding at least one flight e.g. data regarding passengers of the flight and/or regarding agents or equipment used to process them. This data is received from any airport information system (e.g. such as DCS) and/or airline ticketing system and/or with agent and/or sensor deployment system, to yield new data regarding the flight e.g. new data regarding passengers of the flight and/or regarding agents or equipment used to process them which may in turn be provided to airport information systems and/or with airline ticketing systems and/or deployment systems.

It is appreciated that the system herein is more efficient than existing airport systems in terms of saving computer memory and/or increasing processing speed and/or improved user interface by providing data (typically more than is conventionally available) in real time or in near real time, to at least one category of end-user (e.g. at least one of airline personnel, security agents and supervisors thereof, and airport or government personnel). For example, the subsystem e.g. ROM system (aka ROM planning system) which may dispatch live or human resources or document scanners or cameras, responds much faster to needs in view of the fact that a real time indication of data relevant to dispatching, is available. For example, the HRFX cloud may send data to ROM, over a data connection therebetween, which predicts or indicates pressure or load on security agents or scanners or cameras, and/or data regarding delays and/or cancellations of flights; the system may, responsive to delay of an aircraft, time-shift the load of handling the passengers on the delayed aircraft and may reduce load, responsive to flight cancellation. Also, since agents who may inter alia operate document scanners or cameras, are also end-users of the system, the ROM may receive data provided directly by agents who, as end-users, provide indications that they have, de facto, checked in and out of their tasks and shifts. Also, the system may provide employee e.g. agent management software e.g. ROM with data, identifying delayed transfer passengers. The ROM may then deploy agents and/or sensors such as document scanners or cameras, accordingly. This data identifying delayed transfer passengers may be generated by the system of the present invention receiving data e.g. from an airport information system indicative of a delayed incoming aircraft due to arrive late, and looking up (by interfacing with e.g. an airline ticketing system) how many passengers from the delayed incoming aircraft are transferring to a given departing flight, and then, dispatching human resources to service the given departing flight accordingly (e.g. by delaying deployment of a number of agents, responsive to the number of passengers delayed and to the length of the delay). Also, an HRFX Web service may provide typically bi-directional data communication between an airline ticketing system and DCS airport system.

References to “agents” herein may be replaced by references to sensors which may be used for processing passengers.

Data communication between systems includes provision of data by an end-user or server of system A to an end-user or server of system B.

It is appreciated that according to certain embodiments, a server or software system is provided for use by end-users (e.g. Security company or security organization) which operate a team of security agents, typically in a specific airport. This server interfaces (e.g. Via one or more suitable API/s) with external system/s such as airport software systems and/or airline software systems and/or software systems for law enforcement agencies such as border police or military police and/or international agency software systems. typically the server collects relevant data e.g. time-stamped data, regarding passengers passing through “its own” airport e.g. as described herein.

An API may be configured to provide, say, a separate secure channel and/or secure environments for each entity (airline/airport/intl or govt agency) and/or for each flight. thus if the security organization is servicing 3 flights offered by a single airline, 3 channels and/or 3 secure environments may be defined by the security organization's server and/or if 2 airlines are associated with a single flight, 2 channels and/or 2 secure environments may be defined by the security organization's server.

A separate API may be provided for each of several airlines, for example.

The API may be SOAP-based (acronym for Simple Object Access Protocol) or any other suitable messaging protocol specification for exchanging structured information in implementing web services in computer networks, may be used.

According to certain embodiments, the server (e.g. Hrfx cloud) is in data communication with at least one web service which provides secure communication between the server herein and an external system, say, an airline software system e.g. At least one respective airline software system. Typically, when a transfer (say) passenger presents himself (e.g. For the first time, as opposed to a passenger whose presence in the airport is already known) the server determines the airline of the transfer passenger's arriving flight and triggers a query to the web service which communicates with that airline's software system.

The server may be operative to collect data e.g. Departure time and/or gate, of a transfer passenger arriving from an airport x, from an API of airport x.

By virtue of this communication between systems, an ecosystem is provided which provides better security and/or a better user experience for passengers. for example, time-stamped information regarding security checks passed by a given passenger may be shared between systems. Also, data regarding security checks required by a given passenger may be collected. this allows the system to administer (e.g. via suitable hardware) to each passenger, only security checks that passenger needs, which have not yet been administered to that passenger. Hardware-executed security checks may include, say, a metal detector for scanning suitcases or passenger's body and/or an ETD (e.g. as described in https://en.m.wikipedia.orgiwiki/Explosives_trace_detector, and/or a scanner to scan a passport or boarding pass, to OCR the scan, and to detect forgeries or suspicious information e.g. from the OCR.

Typically. time-stamped information is kept in a system database for a limited window of time e.g. Of 72 hours duration, starting from the time-stamp at which the passenger first encounters an airport station (e.g. Baggage check in, security, departure gate, cordoned-off gate area, etc.) Associated with one of the systems in the eco-system (typically with the system server of the security organization). The duration may be selected to be short enough to comply with relevant privacy regulations (e.g. General data protection regulation aka gdpr) and long enough to ensure availability of data when needed (e.g. For as long as the passenger is in the airport or in the air on a flight leaving the airport, the data remains, whereas once the passenger has disembarked at his next airport, the data need not be kept).

Due to the time-stamping, it is possible to “follow” a passenger as he enters an airport, goes through the airport, e.g. From one station to another, and exits the airport e.g. By boarding a departing plane through a gate, and to determine whether s/he already passed certain checks, which the security organization is required to provide, while s/he was in the airport. And/or, it is possible to know whether the passenger is a transfer passenger, and if so, from which airport and country did s/he transfer from.

The database may also include information regarding security checks required by (administered by) various airports and/or other characterizations of airports and/or of airlines and/or of countries which may have been used by a transfer passenger to reach the current airport. For example, some airports may have a higher safety score than others. It is appreciated that typically. all transfer passengers arriving at the airport associated with the server on a given flight, typically arrived from the same airport.

According to certain embodiments, the security system for securing an airport A includes all or any subset of:

Hardware devices, typically deployed at airport A, configured for performing security checks e.g. as described herein and, typically, in data communication with the server, and/or

A data base storing data regarding passengers arriving at the airport wherein data regarding each passenger arriving at time t is stored for a limited amount of time starting from time t; and/or

A server including a hardware processor configured to collect said data, and to derive, from said data, first information indicating which security checks at least one passenger p has already undergone, in airport A and/or in a remote airport from which passenger p has transferred to airport A, and second information indicating which security checks passenger p is required to undergo, and, by comparing said first information and said second information, providing an output indication, to at least one of said hardware devices and/or to at least one human operator thereof, of at least one security check that passenger p has still to undergo.

This typically ensures that the hardware devices at airport A administer to passenger p, only those security checks that passenger p has still to undergo. not security checks that passenger p is not required to undergo, and not security checks that passenger p has already undergone, either in airport A or in the remote airport from which passenger p transferred to airport A.

The server may for example configure at least one of the hardware devices, differently for different passengers. For example, a higher detection threshold may be used for one passenger, and a lower detection threshold may be used for another. Or, weights assigned to various parameters measured by a hardware device may be different from one passenger to another. Or, a given hardware device may be actuated or activated to apply a security check when a first passenger presents himself or herself, and may remain inactive or sleeping, thus may not apply the same security check at all. when a second passenger presents himself or herself. Or, a given hardware device may be actuated or activated to apply a longer and/or more onerous security check when a first passenger presents himself or herself, and may remain apply a more brief and/or less onerous security check when a second passenger presents himself or herself, relative to what the first passenger undergoes. Configuring the hardware devices e.g. assigning of weights, may be responsive inter alia to filtering rules which may be provided by government agencies.

Typically, the hardware processor collects at least one data element about passengers which have transferred to airport A from a remote airport which is not collected for passengers which have not transferred to airport A from a remote airport. This data element may include information indicative of security checks that at least one passenger underwent in a remote airport from which passenger p has transferred to airport A and/or this data element may include information indicative of a time that at least one passenger's flight, which took off from the remote airport, is scheduled to land at airport A.

It is appreciated that the data element/s collected about transfer passengers are highly useful because in practice, it turns out that a considerable proportion of passengers boarding any given aircraft are transfer passengers, typically over 50%, or approximately 70%. Thus for example, knowing which security checks each transfer passenger has undergone in the remote airport from which s/he transferred to airport A can considerably reduce the load on the security agents processing the flights to which the transfer passengers are, via airport A, transferring. And/or, knowing which passengers are transfer passengers and knowing time/s at which those transfer passengers are to arrive at airport A can significantly aid managers of the fleet of security agents (and/or hardware devices performing security checks) at airport A in deploying security agents and hardware devices at the right times and places, within airport A.

The database may be accessible by statistical functionality which is operative to collect statistics on sets of passengers travelling on a given aircraft, to determine a typical breakdown of such sets of passengers (% transfers, % traveling alone vs. With family, % requiring manual processing rather than hardware-executed processing at each station, % requiring last-minute checks e.g. Due to being flagged or selected as security risks while in the airport or a few hours or day or so beforehand, and so forth).

According to certain embodiments, a “stickerless” process does not rely on a sticker pasted onto, say, a boarding pass or other document borne by a passenger and, instead, uses a digital process e.g. As above, to “follow” a passenger who has arrived at an airport (either by land or via an incoming aircraft) until s/he eventually takes off on a departing aircraft. Typically, each time a passenger comes up to an agent or station, the passenger's passport or boarding pass is scanned, a unique identifier e.g. Passport number is ocr'ed or otherwise derived (or the passenger may be biometrically recognized), and the passenger is then looked up in the system database to find the entry generated for the passenger, when he first encounters an agent or physical station. Typically only the security organization has access to the database and other systems such as airport software systems and/or airline software systems and/or software systems for law enforcement agencies do not have access to the database.

The database may for example store passenger name records (PNR) which according to Wikipedia may include “a record in the database of a computer reservation system (CRS) that contains the itinerary for a passenger or a group of passengers travelling together. The concept of a PNR was first introduced by airlines that needed to exchange reservation information in case passengers required flights of multiple airlines to reach their destination (“interlining”). For this purpose, IATA and ATA have defined standards for interline messaging of PNR and other data through the “ATA/IATA Reservations interline Message Procedures—Passenger” (AIRIMP). There is no general industry standard for the layout and content of a PNR. In practice, each CRS or hosting system has its own proprietary standards, although common industry needs, including the need to map PNR data easily to AIRIMP messages, has resulted in many general similarities in data content and format between all of the major systems. When a passenger books an itinerary, the travel agent or travel website user will create a PNR in the computer reservation system it uses. This is typically one of the large global distribution systems, such as Amadeus, Sabre, or Travelport (Apollo, Galileo, and Worldspan) but if the booking is made directly with an airline the PNR can also be in the database of the airline's CRS. This PNR is called the Master PNR for the passenger and the associated itinerary. The PNR is identified in the particular database by a record locator. When portions of the travel are not provided by the holder of the master PNR, then copies of the PNR information are sent to the CRSs of the airlines that will be providing transportation. These CRSs will open copies of the original PNR in their own database to manage the portion of the itinerary for which they are responsible. Many airlines have their CRS hosted by one of the GDSs, which allows sharing of the PNR. The record locators of the copied PNRs are communicated back to the CRS that owns the Master PNR. so all records remain tied together. This allows exchanging updates of the PNR when the status of trip changes in any of the CRSs.”

Typically, the database stores pnrs provided by other systems before passengers arrive at the airport; typically a few hours or a few dozen hours beforehand, such as 30 hours before, or a few days, or less. It is appreciated that, therefore, some aspects of the PNR data as stored by the database may be incorrect, by the time the relevant passenger arrives at the airport.

Also, some data may be unavailable until the live passenger actually arrives at the airport for other reasons, such as visa information, and whether the visa held by the passenger actually suffices (e.g. According to IATA standards) for the passenger's destination. The server may complete this data when the live passenger arrives, including by querying other systems if/as appropriate.

From a technical point, some parts of a PNR may be required before the booking can be completed e.g. all or any subset of (according to Wikipedia):

“The name of the passenger

Contact details for the travel agent or airline office.

Ticketing details, either a ticket number or a ticketing time limit.

Itinerary of at least one segment, which must be the same for all passengers listed.

Name of the person providing the information or making the booking.”

Other information, e.g. a timestamp and/or an agency's pseudo-city code, may be incorporated into the booking automatically.

All entered information may be retained in the “history” of the booking according to wikipedia, which goes onto say that typically, “Once the booking has been completed to this level, the CRS will issue a unique all alpha or alpha-numeric record locator, which will remain the same regardless of any further changes made (except if a multi-person PNR is split). Each airline will create their own booking record with a unique record locator, which, depending on service level agreement between the CRS and the airline(s) involved, will be transmitted to the CRS and stored in the booking. If an airline uses the same CRS as the travel agency, the record locator will be the same for both.”

Other information in a PNR may include all or any subset of, according to wikipedia:

“Fare details, (although the amount may be suppressed, the type of fare will be shown), and any restrictions that may apply to the ticket.
Tax amounts paid to the relevant authorities involved in the itinerary.
The form of payment used. as this will usually restrict any refund if the ticket is not used.
Further contact details, such as agency, phone number and address, additional phone contact numbers at passenger address and intended destination.
Age details if it is relevant to the travel, e.g., unaccompanied children or elderly passengers requiring assistance.
Frequent flyer data.
Seat allocation (or seat type request).
Special Service Requests (SSR) such as meal requirements. wheelchair assistance. and other similar requests.
“Optional Services Instruction” or “Other Service Information” (OSI)—information sent to a specific airline, or all airlines in the booking, which enables them to better provide a service. This information can include ticket numbers, local contacts details (the phone section is limited to only a few entries), airline staff onload and upgrade priority codes, and other details such as a passenger's language or details of a disability.
Vendor Remarks. VRs are comments made by the airline, typically generated automatically once the booking or request is completed. These will normally include the airline's own record locator. replies to special requests, and advice on ticketing time limits. While normally sent by the airlines to an agent, it is also possible for an agent to send a VR to an airline . . . .
Passengers' gender
Passport details—nationality, number, and date of expiry
Date and place of birth
Redress number (if previously given to the passenger by the US authorities).
All available payment/billing information.”

According to Wikipedia, “the components of a PNR are identified internally in a CRS by a one-character code. This code is often used when creating a PNR via direct entry into a terminal window (as opposed to using a graphical interface). The following codes are standard across all CRSs based on the original PARS system:
Name
   0 Segment (fight) information, including number of seats booked, status code (for example HKI—confirmed for one passenger) and fare class
   1 Related PNR record ids.
   2 PNR owner identification (airline, CRS user name and role)
   3 Other airline Other Service Information (OSI) or Special Service Request (SSR) items
   4 Host airline OSI or SSR items

### 5 Remarks

6 Received from
7 Ticketing information (including ticket number)
8 Ticketing time limit
9 Contact phone numbers”.

Airlines and travel agencies may host their PNR databases with a computer reservations system (CRS) or global distribution system (GDS) e.g. as available from Sabre, Galileo. Worldspan and Amadeus.

It is appreciated that the server may maintain database/s storing data characterizing each of plural airlines and/or each of plural airports. For example, database/s may store which security checks airline x requires security company to administer to passengers whose destination is country y. and/or database/s may store which security checks are performed on passengers flown from country w via airline z to the current airport.

It is appreciated that any suitable APIs may be used by the server described herein, and different APIs may be used to communicate with different external systems, such as various airline systems, various airport systems, etc. for example, the server may communicate with a first airline via ftp, with another airline via a live web api, with another the server may use a public api. REST API's may be used, but not necessarily. Soap web services may be used, but not necessarily.

For the REST (say) API, there may be a connection between Parse (logging), App installed on the devices. Elastic datasource. A filtering service may use any suitable ruleset and may use a suitable windows service to read files stored on a windows server, which were transferred by Airlines to, say, a special SFTP folder (and may be decrypted), stores filtered data from APS files to elastic datasource. MSqI data source may be used as a temporary storage.

The REST API and/or Parse may be hosted on a cloud e.g. Azure Cloud and may be configured per region to optimise speed of connection between devices and other components. The REST API may be associated with a connection between Parse (logging), App installed on the devices, Elastic datasource. A second filtering service with a suitable ruleset, which may be developed for all locations in the world may be employed. Typically, a windows profiling service reads files stored on windows server. which are transferred by Airlines to the special SFTP folder (and may be decrypted), stores filtered or profiled data from the APS files to elastic datasource. MSql data source may be used as a temporary storage.

All connections between all components are encrypted and the personal data in elastic is also encrypted and complies with the general rules.

The following procedure may be performed periodically e.g. daily, to allow the server to collect information from an airline software system: Suitable formats for SOAP Request messages and for SOAP Response messages may be agreed upon. Suitable formats for SOAP Response Business fault messages and for SOAP Response System Fault messages may be agreed upon, to facilitate data exchange between the server (aka sender) and the airline software system. a secure connection may be established between the server and the airline software system. Data exchanged may include data gathered from a passenger's Boarding Pass and/or a Passport scan of a passenger at a security check performed by an agent in the airport on the live passenger. Alternatively, data may flow only from the airline software system to the server and not from the server to the airline software system.

The Sender may send data acquired from the Boarding Pass and/or Passport scan of the passenger to the airline. After data has been processed by the airline, the airline may notify the Sender on the result, via a Response Notification message. Scanned data may be interpreted and preserved as an XML request and may be sent to the airline. The Sender may use a suitable SOA architecture with Request/Reply pattern for communication. This pattern may be based on a stateless web services architecture. The airline may provide to Sender the WSDL (Web Services Description Language) specifications for the Request and Reply messages to be implemented by the Sender party. Messages sent to the airline and/or received from the airline by the Sender may comply with an agreed upon Data Type Schema definition e.g. in the WSDL.

Data may be transported in XML format and may be structured confirming the Data Type Schema Definition provided with Consumer WSDL. A SOAP standard, e.g. 1.1 standard. may be followed for message communication. Within airline context, the <soap:Header> may be used to pass airline-related information that is to be processed by SOAP nodes along the message path in order to secure the service access and to keep an end-to-end traceability. A soap:Header construct typically establishes a location for supplementary metadata organized into header blocks. This information may be used by various programs to help relay and/or forward a message and/or process its contents. Any suitable soap: Header XML Layout may be employed.

A SOAP (say) Request message may include Boarding Pass string information and/or MRZ (machine readable zone) structured data.

A SOAP (say) Response message may include an OK result.

A format for SOAP (say) Response Business fault messages may be provided. Business errors may indicate that input data violates business integrity. Business Faults may be carried within the structure of the standard SOAP Fault message with a specific detail element. the exact name of the Business Fault is typically specific for a service and may be explicitly defined, e.g. in the SOAP binding within the WSDL as a possible response.

A SOAP (say) Response System Fault message may indicate that somewhere along the path of the SOAP request message, a SOAP node or infrastructure component cannot work properly (provider cannot be reached, consumer is not authorized to invoke the web service, error on XML validation or something else). System Fault messages may transmit System errors which indicate unforeseen technical circumstances during message processing (Database not available, etc.)

Fault resolution and logging: All fault messages received from the airline by the Sender may be logged at the Sender side, thus allowing close investigation of accuracy when needed. Sender may be allowed to make Support Tickets at an airline provided Support Ticketing System. Both Sender and airline may be responsible for issue resolution on their respected sides when the issue origin has been determined and agreed upon. On the Sender side an automatic Alert system may be put in place to notify the support staff, if and when issues have occurred. Sufficient information on the issue will be provided via an alert to make preliminary analysis possible where in the process the issue has occurred. The issue can occur either on the Sender side before message has been formed and send, or it can occur on the airline side during the connection to the Consumer endpoint, during message transfer or during message processing by the airline software.

Security: the Sender may interact with the airline over Private Network (IP) and may be required to comply with suitable requirements e.g. all or any subset of the following.

In a Confidential message exchange, encrypted communication may be implemented between the Sender and the airline. the HTTPS protocol, e.g. HTTP over TLS1.2, may be employed.

Re Access rights, the airline credentials, e.g. based on Username Token Profile, may be used to authenticate who is calling what. Each Web Services consumer may be required to use the airline credentials to invoke an airline service. To realize this requirement the WS-Security header block may be used within soap:Header. At runtime, the SOA consumer credentials may be presented at message level and they are embedded in the SOAP-Header by using WSSE (username and password); the password field is protected using transport level security (TLS). Beyond authentication, each service may be subject of authorization access.

WS-Addressing header may be used to provide the type of action and/or intended airline partner URL and.or the MessageID for traceability.

Any suitable soap: Envelope may be employed. Any suitable WS-Addressing may be employed.

Any suitable Private Network architecture may be employed.

PAX Data may be filtered in real time or in near-real time. The Sender may send BoardingPass string and MRZ Passport information. However if sender sends an agreed upon indicator to the airline, sender may request not only swipe result but additional results e.gl all or any subset of the following:

```
PAX Information
  Complete itinerary
  DirectEmployee
  PAXTags
  Frequent Flyer
    Membership level
    Miles
    Membership code
    ShareAirlineCode
```

If the provided PNR from the Boardingpass contains multiple PAX, the airline may provide all or any subset of the above information for all of them including, for each passenger, the passenger's Firstname and Lastname.

According to certain embodiments, an MRZ to PNR algorithm may be employed. For example, when a PAX does not yet have a boarding pass (e.g. before check-in) the system may match MRZ passport information to PNR information that the server herein may have on file of the airline. Machine learning may be used to generate an algorithm which accommodates for PAX which have double surnames and when booking the tickets may use combination of their 1 or 2 surnames, sometimes with slightly different spellings, such that identicality of PNR information and passport information, for a given passenger, cannot be assumed. The algorithm may for example present possible candidate matches for a given live passenger, to the agents. For most passengers, the first suggested match will be correct, for some passengers, 2 suggested matches may be needed, for a small number of passengers, 3 suggested matches may be needed, and a very small percentage of passengers may not be matched.

According to certain embodiments, information indicating which security checks passenger p is required to undergo may be provided by, or inter alia by, a rule-based filtering subsystem e.g. the NAP-S system shown and described herein. Rules may for example be applied (at least) to a passenger's PNR information. a passenger may even be declared green or approved, without undergoing any security checks at a given gate or other security station, and may merely confirm at that point, their identity.

This system typically determines which of a group of passengers who are to fly out of the airport on a given flight are known, typically based on system-stored rules, to be low security risks. The server may command hardware devices which apply security checks to passengers (and/or may provide an output indication to operators of such hardware devices) to apply less security checks, and/or to apply security checks, if at all, which are less invasive/onerous, to passengers known to have a low security risk, relative to other passengers whose level of security risk cannot be determined and who therefore underdo more security checks and/or undergo security checks which are more invasive/onerous such as a full baggage search rather than a less time-consuming alternative for greenlighting baggage. Government agencies may provide system-stored rules; it is appreciated therefore that a server deployed at an airport in country x may thus have different system-stored rules relative to a server deployed at an airport in country y.

A particular advantage of certain embodiments is that when a passenger who was filtered out is later selected for security checks, due to last minute considerations, the system of the present invention can easily determine where the passenger is since the system has time-stamped indications of which stations each passenger has already passed (and hence of stations the passenger has not yet passed).

It is appreciated that terminology such as “mandatory”, “required”, “need” and “must” refer to implementation choices made within the context of a particular implementation or application described herewithin for clarity and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia. are electromagnetic signals in accordance with the description herein. These may carry computer-readable instructions for performing any or all of the operations of any of the methods shown and described herein, in any suitable order, including simultaneous performance of suitable groups of operations, as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order, any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform, e.g. in software, any operations shown and described herein; information storage devices or physical records, such as disks or hard drives, causing at least one computer or other device to be configured so as to carry out any or all of the operations of any of the methods shown and described herein, in any suitable order, at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally including at least one of a decision, an action, a product, a service or any other information described herein that impacts, in a positive manner, a problem or objectives described herein; and (b) outputting the solution.

The system may, if desired, be implemented as a network—e.g. web-based system employing software, computers, routers and telecommunications equipment, as appropriate.

Any suitable deployment may be employed to provide functionalities e.g. software functionalities shown and described herein. For example. a server may store certain applications, for download to clients, which are executed at the client side, the server side serving only as a storehouse. Any or all functionalities, e.g. software functionalities shown and described herein, may be deployed in a cloud environment. Clients e.g. mobile communication devices such as smartphones, may be operatively associated with, but external to the cloud.

The scope of the present invention is not limited to structures and functions specifically described herein and is also intended to include devices which have the capacity to yield a structure. or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once. typically on an “if and only if” basis e.g. triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may, for example, comprise changing the state or condition, or may more generally cause any outcome which is technically advantageous given the state or condition or data, and/or may prevent at least one outcome which is disadvantageous given the state or condition or data. Alternatively or in addition. an alert may be provided to an appropriate human operator or to an appropriate external system.

Features of the present invention, including operations, which are described in the context of separate embodiments, may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art, and particularly although not limited to those described in the Background section or in publications mentioned therein.

Conversely, features of the invention, including operations, which are described for brevity in the context of a single embodiment or in a certain order, may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g. as illustrated or described herein.

Devices, apparatus or systems shown coupled in any of the drawings may in fact be integrated into a single platform in certain embodiments, or may be coupled via any appropriate wired or wireless coupling such as but not limited to optical fiber, Ethernet, Wireless LAN, HomePNA, power line communication, cell phone, Smart Phone (e.g. iPhone). Tablet, Laptop, PDA, Blackberry GPRS, Satellite including CPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation, and is not intended to be limiting.

Any suitable communication may be employed between separate units herein e.g. wired data communication and/or in short-range radio communication with sensors such as cameras e.g. via WiFi, Bluetooth or Zigbee.

It is appreciated that implementation via a cellular app as described herein is but an example, and, instead, embodiments of the present invention may be implemented, say, as a smartphone SDK; as a hardware component; as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node).

Any operation or characteristic described herein may be performed by another actor outside the scope of the patent application and the description is intended to include apparatus whether hardware, firmware or software which is configured to perform, enable or facilitate that operation or to enable, facilitate or provide that characteristic.

The terms processor or controller or module or logic as used herein are intended to include hardware such as computer microprocessors or hardware processors, which typically have digital memory and processing capacity, such as those available from, say Intel and Advanced Micro Devices (AMD). Any operation or functionality or computation or logic described herein may be implemented entirely or in any part on any suitable circuitry including any such computer microprocessor/s as well as in firmware or in hardware or any combination thereof.

It is appreciated that elements illustrated in more than one drawings, and/or elements in the written description may still be combined into a single embodiment, except if otherwise specifically clarified herewithin. Any of the systems shown and described herein may be used to implement or may be combined with, any of the operations or methods shown and described herein.

It is appreciated that any features, properties, logic, modules, blocks, operations or functionalities described herein which are, for clarity, described in the context of separate embodiments, may also be provided in combination in a single embodiment, except where the specification or general knowledge specifically indicates that certain teachings are mutually contradictory and cannot be combined. Any of the systems shown and described herein may be used to implement or may be combined with, any of the operations or methods shown and described herein.

Conversely, any modules, blocks, operations or functionalities described herein, which are, for brevity, described in the context of a single embodiment. may also be provided separately or in any suitable sub-combination. including with features known in the art. Each element, e.g operation described herein, may have all characteristics and attributes described or illustrated herein, or, according to other embodiments, may have any subset of the characteristics or attributes described herein.

It is appreciated that apps referred to herein may include a cell app, mobile app, computer app or any other application software. Any application may be bundled with a computer and its system software, or published separately. The term “phone” and similar used herein is not intended to be limiting and may be replaced or augmented by any device having a processor, such as but not limited to a mobile telephone, or also set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node). Thus the computing device may even be disconnected from e.g., WiFi, bluetooth Bluetooth etc., but may be tethered directly or ultimately to a networked device.

1. An airport security eco-system comprising:
plural client applications each including a hardware processor configured for use by security agents conducting security screening of passengers, thereby to generate individual passenger data characterizing individual passengers;
plural companion applications each including a hardware processor configured for use by personnel other than said security agents who require information derived from said individual passenger data, the personnel including at least one of airport authorities and government authorities, and
a cloud service that manages passenger data, typically including HRF passenger data,
and provides data connectivity between the client and companion applications including communicating said data to, from and between the client and companion applications.

2. The system of claim 1, wherein said information comprises at least a portion of said passenger data.

3. The system of claim 1, wherein said client applications are each configured to scan at least one physical document, such as a passport or boarding pass, borne by passengers.

4. The system of claim 1, wherein said data is communicated between the client and companion applications in near-real time.

5. The system of claim 1, wherein said data is communicated to the cloud service in near-real time.

6. The system of claim 1, wherein said data is communicated from the cloud service in near-real time.

7. The system of claim 1, wherein said cloud service is operative to present, to at least one security agent using at least one client application, biometric information regarding at least one passenger gathered by the cloud service via an authentication connector aka biometric connector from a legacy biometric backbone deployed in an airport.

8. The system of claim 1 wherein said cloud service is operative to generate a display data provided by a boarding connector, which interfaces with a legacy departure control system (DCS), wherein the display is presented to at least one security agent using at least one client application.

9. The system of claim 1, and also comprising a passenger filtering subsystem which gathers PNR data from at least one airline and applies rules to said PNR data.

10. The system of claim 9, and wherein said rules are modifiable via at least one of said plural companion applications.

11. The system of claim 1, wherein the system interfaces with employee management software, thereby to facilitate management of at least the security agents, and wherein the system provides the employee management software with passenger flow data derived from said individual passenger data.

12. The system of claim 1, wherein the system interfaces with employee management software, thereby to facilitate management of at least the security agents, and wherein the system provides the employee management software with data, identifying delayed transfer passengers, which is generated by learning from an airport information system of a delayed incoming aircraft due to arrive late, and looking up (e.g. by interfacing with an airline ticketing system) how many passengers from the delayed incoming aircraft are transferring to a given departing flight.

13. The system of claim 1, wherein said individual passenger data includes at least one of the following: HRF passenger data, Birthdate, DocumentNumber, FamilySize, Gender, GroupSize, Family, Continuous Itinerary, FirstNameSecret, LastNameSecret, FirstNameFull, LastNameFull, FirstName3Char, FirstName4Char, FirstName5Char, LastName3Char, LastName4Char, LastName5Char, Itinerary, PNR Code, Transit, PaxAQQ, SegmentAirportCodes, TotalSegments, Carrier, FlightNumber, Departure, DepartureTime, Destination, DestinationTime, Origin, OriginTime, and HasAPSCode.

14. The system of claim 1, wherein the cloud service securely manages passenger data, including HRF passenger data.

15. An efficient flight security method comprising;
providing data in real time or in near-real time, to and from plural systems, including at least one airport system and/or at least one airline system and/or at least one agent/equipment management system which deploys agents and/or equipment servicing passengers of flights by providing security approval thereof.

16. A method according to claim 15 and wherein the method also comprises generating new data in real time, responsive to data provided in real time by at least a first system from among said plural systems, wherein said new data characterizes passengers of at least one flight and/or agents or equipment used to provide security approval of the passengers of the at least one flight, and providing said new data in real time to at least a second system from among said plural systems.

17. A security system for securing an airport A, the system comprising:
Hardware devices for performing security checks; and
A data base storing data regarding passengers arriving at the airport wherein data regarding each passenger arriving at time t is stored for a limited amount of time starting from time t; and
A server including a hardware processor configured to collect said data, and to derive, from said data, first information indicating which security checks at least one passenger p has already undergone, in airport A and/or in a remote airport from which passenger p has transferred to airport A, and second information indicating which security checks passenger p is required to undergo, and, by comparing said first information and said second information, providing an output indication, to at least one of said hardware devices and/or to at least one human operator thereof, of at least one security check that passenger p has still to undergo,
Thereby to ensure that the hardware devices administer to passenger p, only those security checks that passenger p has still to undergo, not security checks that passenger p is not required to undergo, and not security checks that passenger p has already undergone, either in airport A or in the remote airport from which passenger p transferred to airport A.

18. A system according to claim 17 and wherein said hardware processor is operative to collect at least one data element about passengers which have transferred to airport A from a remote airport which is not collected for passengers which have not transferred to airport A from a remote airport.

19. A system according to claim 18 wherein said data element includes information indicative of security checks that at least one passenger underwent in a remote airport from which passenger p has transferred to airport A.

20. A system according to claim 18 wherein said data element includes information indicative of a time that at least one passenger's flight, which took off from the remote airport, is scheduled to land at airport A.

21. A computer program product, comprising a non-transitory tangible computer readable medium having computer readable program code embodied therein, said computer readable program code adapted to be executed to implement an efficient flight security method comprising providing data in real time or in near real time, to and from plural systems, including at least one airport system and/or at least one airline system and/or at least one agent/equipment management system which deploys agents and/or equipment servicing passengers of flights by providing security approval thereof (e.g. hardware devices for administering security checks to passengers).
